(19) United States
(12) Patent Application Publication
(10) Pub. No.: US 2017/0054373 A1
(43) Pub. Date: Feb. 23, 2017

(54) DC-DC VOLTAGE CONVERTER

(71) Applicant: Robert Bosch GmbH, Stuttgart (DE)

(72) Inventor: Istvan FATER, Budapest (HU)

(21) Appl. No.: 15/239,488

(22) Filed: Aug. 17, 2016

(30) Foreign Application Priority Data
Aug. 18, 2015 (DE) 10 2015 215 702.4

(51) Int. Cl. H02M 3/158

(52) U.S. Cl. CPC H02M 3/158

(57) ABSTRACT

A DC-DC voltage converter includes a first and a second boost converter, each of the boost converters including an inductor and a controllable switch, the boost converters being cascaded so that an output voltage of the first boost converter corresponds to an input voltage of the second boost converter; and a control unit for controlling the switches of both boost converters in order to open and close the switches. Thus, the switches are controlled by the same signal of the control unit.

### RELATED APPLICATION INFORMATION

The present application claims priority to and the benefit of German patent application no. 10 2015 215 702.4, which was filed in Germany on Aug. 18, 2015, the disclosure of which is incorporated herein by reference.

### FIELD OF THE INVENTION

The present invention relates to a DC-DC voltage converter. In particular, the present invention relates to a DC-DC voltage converter with a high conversion ratio.

### BACKGROUND INFORMATION

A DC-DC voltage converter may be used to convert an input voltage into an output voltage, the output voltage being greater than the input voltage and both voltages being DC voltages. Different technologies, which have different advantages and disadvantages, are known for configuring a DC-DC voltage converter.

An easily configured DC-DC voltage converter includes a boost converter which may basically be configured including an inductor, a switch, a diode, and a capacitor. In addition, a control unit may be provided to periodically open and close the switch. Generally, the switch is controlled with the aid of a pulse width modulated signal (PWM signal), a duty cycle between an on time and an off time of the PWM signal influencing a conversion factor of the boost converter. Such a boost converter may be controlled to achieve a conversion factor of approximately 1 to 9.

The conversion factor of the boost converter is, however, limited in principle. In order to implement a higher conversion factor, another DC-DC voltage conversion technology must therefore by used or multiple boost converters may be connected in series (cascaded). Therefore, a control unit, which controls the switch as a function of an output voltage of the respective boost converter, is assigned to each boost converter. This type of approach is, however, relatively expensive and may thus lead to increased production costs.

### SUMMARY OF THE INVENTION

An underlying object of the present invention is to provide an improved DC-DC voltage converter. The present invention achieves this object with the aid of the subject matter of the descriptions herein, and the further descriptions herein provide specific embodiments.

A DC-DC voltage converter includes one first and one second boost converter, each of the boost converters including an inductor and a controllable switch, the boost converters being cascaded so that an output voltage of the first boost converter corresponds to an input voltage of the second boost converter, and a control unit is provided to control the switches of both boost converters in order to open and close the switches. The switches are thereby controlled by the same signal from the control unit.

By dispensing with a second control unit, the DC-DC voltage converter may be simply configured. By cascading the two boost converters, the individual conversion factors may thereby be multiplied together to yield the conversion factor for the DC-DC voltage converter. The conversion factor of the DC-DC voltage converter may thus be very large and may be approximately 20 or more, particularly 50 or more. In one specific embodiment, the conversion factor of the DC-DC voltage converter lies in a range between one and 100.

In one particular specific embodiment, the signal from the control unit is controlled as a function of an output voltage of the second boost converter. Thus, the two boost converters may be treated like one single boost converter on the part of the control unit.

In another specific embodiment, the signal from the control unit may be additionally controlled as a function of a current flowing through the DC-DC voltage converter. Thus, a variable electrical load on the DC-DC voltage converter may be better adjusted.

It furthermore may be the that the switches are controlled with the aid of a pulse width modulated signal (PWM signal). The signal from the control unit may include, in particular, a single square wave signal. The PWM signal may be easily generated and is well suited for controlling the switches. The switches may thereby be configured, in particular, as semiconductor switches, for example, as Darlington transistors, field effect transistors, IGBTs, or other controllable semiconductors.

A conversion factor is generally defined for each of the boost converters as the ratio of the input voltage to the output voltage. In a specific embodiment, the conversion factor for each boost converter is a function of a duty cycle of the PWM signal of the control unit.

In another specific embodiment, the control unit is configured to influence the duty cycle of the PWM signal in such a way that the output voltage of the second boost converter corresponds to a predetermined voltage. This voltage may, in particular, be permanently predefined. Both boost converters may thereby be controlled using the same signal or one of the boost converters may be controlled using a permanently predetermined signal while the other is controlled using a signal which is determined on the basis of the output voltage of the second boost converter—and, in particular, its deviation from the predetermined voltage.

It furthermore may be that at least one of the boost converters is operated in such a way that current constantly flows through its inductor. A mode of this type is also known as CCM (Continuous Conduction Mode).

In yet another specific embodiment, the DC-DC voltage converter additionally includes a third boost converter, which is provided cascaded between the first and the second boost converters. In this way, an arbitrary number of boost converters may basically be cascaded one after another, the output voltage of one of the boost converters respectively corresponding to the input voltage of a subsequent boost converter. The switches of all boost converters are controlled with the aid of the same signal. The control may be carried out as a function of an output voltage of the last boost converter in the cascade.

The present invention is now described in greater detail with reference to the appended figures.

### BRIEF DESCRIPTION OF THE DRAWINGS

FIG. 1 shows a circuit diagram of a DC-DC voltage converter.

FIG. 2 shows voltages at the DC-DC voltage converter from FIG. 1.

FIG. 3 shows a circuit diagram of another DC-DC voltage converter on the basis of FIG. 1.

FIG. 4 shows chronological curves of voltages at the DC-DC voltage converter from FIG. 3.

### DETAILED DESCRIPTION

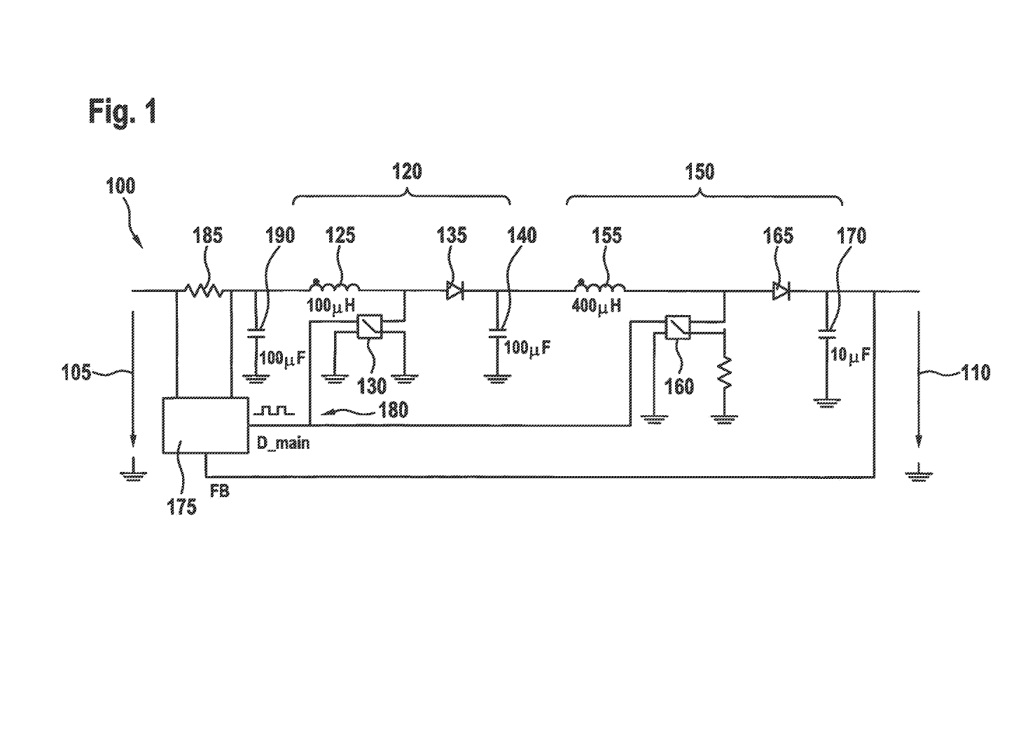

FIG. 1 shows a circuit diagram of a DC-DC voltage converter 100. DC-DC voltage converter 100 is configured to convert an input voltage 105 into an output voltage 110, output voltage 110 being greater than input voltage 105, and both voltages 105, 110 being DC voltages. A conversion ratio of DC-DC voltage converter 100 is defined as the voltage ratio between output voltage 110 and input voltage 105. In the present case, it is assumed that the conversion factor is greater than 1 and, in particular, should be greater than approximately 10.

DC-DC voltage converter 100 includes a first boost converter 120 with a first inductor 125, a first switch 130, a first diode 135, and a first capacitor 140. In addition, DC-DC voltage converter 100 includes a second boost converter 150 with a second inductor 155, a second switch 160, a second diode 165, and a second capacitor 170. Boost converters 120 and 150 are thereby arranged as cascaded, in that an output side of first boost converter 120 is connected to an input side of second boost converter 150. The input side of first boost converter 120 corresponds to the input side of DC-DC voltage converter 100, and the output side of second boost converter 150 corresponds to the output side of DC-DC voltage converter 100.

DC-DC voltage converter 100 additionally may include a control unit 175 for controlling switches 130 and 160 with the aid of a signal 180, which may be formed as a pulse width modulated square wave signal. Control signal 180 is used to open and close both switches 130 and 160 in the same way.

Both boost converters 120 and 150 shown each have a conversion factor, which is essentially 1:(1−D). D is thereby the duty cycle of pulse width modulated control signal 180, which assumes a value between 0% and 100% or between 0 and 1. Each of boost converters 120, 150 is operated in this case using the same conversion factor, an individual boost converter 120, 150 being limited to a maximum conversion factor of approximately 10 in practice. Since, however, both boost converters 120 and 150 are connected in a cascade, the conversion factor of the entire DC-DC voltage converter 100 is determined as the product of the conversion factors of the two individual boost converters 120 and 150. Therefore, conversion factors up to approximately 100 may be set at DC-DC voltage converter 100 in practice.

Control unit 175 may be configured to set control signal 180 as a function of output voltage 110 in such a way that output voltage 110 corresponds to a predetermined value. In addition, control signal 180 may be influenced on the basis of a current flowing through DC-DC voltage converter 100. For this purpose, a series resistor (shunt) 185 is provided, through which the current flows through DC-DC voltage converter 100 and at which a voltage drops which may be sampled by control unit 175. A capacitor 190 may be additionally provided at the input side of first boost converter 120 in order to counteract a vibration tendency of the circuitry of DC-DC voltage converter 100.

In the specific embodiment shown, two boost converters 120 are cascaded in a simple configuration. In other specific embodiments, a buck converter or a buck-boost converter may also be cascaded and controlled with the aid of a shared control signal 180.

DC-DC voltage converter 100 is particularly suited for supplying a battery charging device with a sufficiently high voltage.

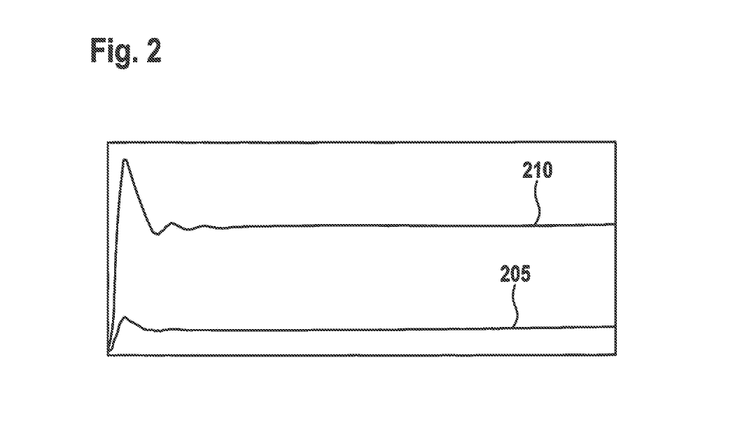

FIG. 2 shows voltages at DC-DC voltage converter 100 from FIG. 1. A time is plotted in a horizontal direction and a voltage is plotted in a vertical direction. A first curve 205 corresponds to the output voltage of first boost converter 120 and thus to the input voltage of second boost converter 150; a second curve 210 corresponds to the output voltage of second boost converter 150, and thus also to the output voltage of DC-DC voltage converter 100. The represented curves 205, 210 relate to a non-regenerated generation of control signal 180. Control signal 180 is thus determined neither as a function of the output voltage of DC-DC voltage converter 100 nor as a function of the current flowing through it. Conversion factors selected as examples for both boost converters 120, 150 are each 5, so that the conversion factor of the entire DC-DC voltage converter 100 is approximately 5×5=25. For this purpose, a PWM signal with a working phase in the range of approximately 80% may be used for controlling boost converters 120, 150, input voltage 105 being approximately 10 V, for example.

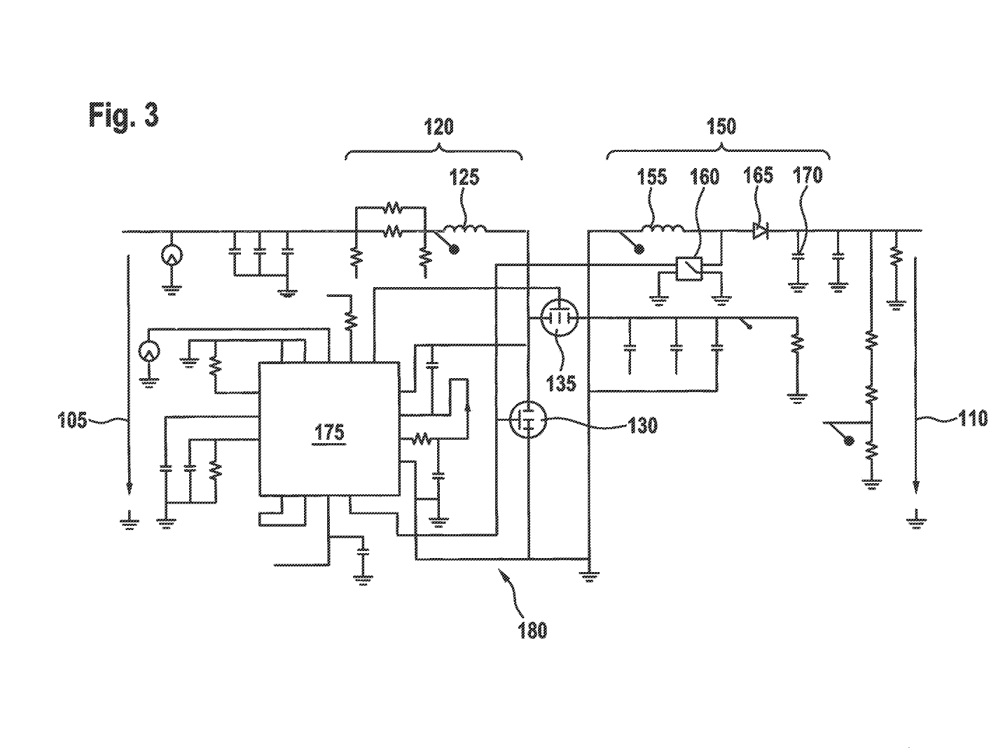

FIG. 3 shows a circuit diagram of another DC-DC voltage converter 100 on the basis of DC-DC voltage converter 100 from FIG. 1. By way of example, an integrated circuit with the designation TPS43060, which is configured for controlling a single boost converter 120, is used as control unit 175.

Corresponding to the specific embodiment of FIG. 1, two boost converters 120, 150 connected in series are again configured, which are controlled with the aid of the same signal 180 of control unit 175. The control of both boost converters 120, 150 is carried out with reference to the output voltage of second boost converter 150. Both boost converters 120, 150, connected in series, behave for control unit 175 like one single boost converter whose conversion factor corresponds to the product of the conversion factors of the first and the second boost converter 120, 150.

In the specific embodiment shown, diode 135 may also be replaced by an additional switch, for example, a field effect transistor which also has known diode properties. This switch may be controlled with the aid of a signal which is the inverse of control signal 180. Additional details of the circuitry may be gathered from the circuitry shown and the data sheet for control unit 175 used.

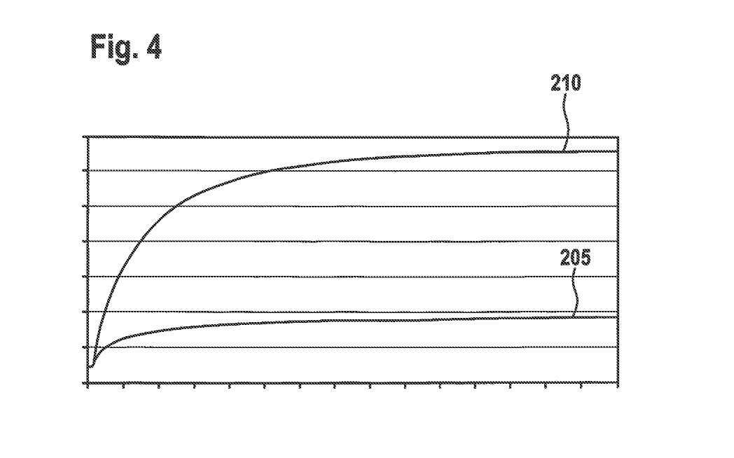

FIG. 4 shows chronological curves of voltages at DC-DC voltage converter 100 from FIG. 3. A time is plotted in the horizontal direction and a voltage is plotted in the vertical direction. The represented curves 205 and 210 correspond to those from FIG. 2. Due to the back coupling of control unit 175 to output voltage 110 of DC-DC voltage converter 100 implemented in the specific embodiment of FIG. 3, a predetermined output voltage may be quickly asymptotically obtained. In the exemplary specific embodiment of FIG. 3, an output voltage of approximately 320 V is achieved on the basis of an input voltage of approximately 24 V. The conversion factor of entire DC-DC voltage converter 100 is therefore approximately 13.3.

What is claimed is:

1. A DC-DC voltage converter, comprising:
a first boost converter and a second boost converter, each of the boost converters including an inductor and a controllable switch, wherein the boost converters are cascaded so that an output voltage of the first boost converter corresponds to an input voltage of the second boost converter; and
a control unit to control the switches of both of the boost converters to open and close the switches;
wherein the switches are controlled by the same signal of the control unit.

2. The DC-DC voltage converter of claim 1, wherein the signal of the control unit is controlled as a function of an output voltage of the second boost converter.

3. The DC-DC voltage converter of claim 1, wherein the switches are controlled with the aid of a pulse width modulated signal.

4. The DC-DC voltage converter of claim 3, wherein a conversion factor between the input voltage and the output voltage at the boost converters is a function in each case of a duty cycle of the pulse width modulated signal.

5. The DC-DC voltage converter of claim 3, wherein the control unit is configured to influence the duty cycle of the pulse width modulated signal so that the output voltage of the second boost converter corresponds to a predetermined voltage.

6. The DC-DC voltage converter of claim 1, wherein at least one of the boost converters is operated so that current permanently flows through its inductor.

7. The DC-DC voltage converter of claim 1, wherein a conversion factor between the input voltage of the first boost converter and the output voltage of the second boost converter is greater than 20.

8. The DC-DC voltage converter of claim 1, further comprising:
a third boost converter which is cascaded between the first and the second boost converter.
